(19) United States
(12) Patent Application Publication
(10) Pub. No.: US 2013/0242693 A1
(43) Pub. Date: Sep. 19, 2013

(54) SEISMIC IMAGING SYSTEM USING A REVERSE TIME MIGRATION ALGORITHM

(71) Applicant: Changsoo SHIN, Seoul (KR)

(72) Inventor: Changsoo SHIN, Seoul (KR)

(73) Assignee: SEOUL NATIONAL UNIVERSITY R&DB FOUNDATION, Seoul (KR)

(21) Appl. No.: 13/798,396

(22) Filed: Mar. 13, 2013

Related U.S. Application Data
(60) Provisional application No. 61/610,087, filed on Mar. 13, 2012.

(51) Int. Cl. G01V 1/36

(52) U.S. Cl. CPC G01V 1/368
USPC 367/9

(57) ABSTRACT

Provided is seismic imaging system, particularly, reverse-time migration for generating a real subsurface image from modeling parameters calculated by waveform inversion, etc. A seismic imaging system includes: a logarithmic back-propagation unit configured to back-propagate a ration of a logarithmic measured wavefield to modeling wavefield; a virtual source estimating unit configured to estimate virtual sources from a sources; and a first convolution unit configured to convolve the back-propagated measured data with the virtual sources and to output the results of the convolution.

### CROSS-REFERENCE TO RELATED APPLICATION

This application claims the benefit under 35 U.S.C. §119(a) of a U.S. Provisional Patent Application No. 61/610,087, filed on Mar. 13, 2012, the entire disclosure of which is incorporated herein by reference for all purposes.

### BACKGROUND

1. Field

The following description relates to seismic imaging, and more particularly, to reverse-time migration for generating a real subsurface image from modeling parameters calculated by waveform inversion, etc.

2. Description of the Related Art

A two-way migration method requires significantly more computational resources than a one-way migration method. However, since the two-way migration method has substantially no dip limitation as well as processing multiarrivals, the two-way migration method allows seismic imaging regardless of the inclination of a reflection surface and also can preserve the real amplitudes of seismic wavefields. For these reasons, the two-way migration method has been widely utilized with the rapid growth of computing technology.

Inverse-time migration is performed by back-propagating field data, that is, measured data. Tarantola showed that reverse-time migration is tantamount to performing the first iteration of full waveform inversion (Tarantola, A., 1984, Inversion of Seismic Reflection Data in the Acoustic Approximation: Geophysics, 49, 1259-1266). Accordingly, as disclosed in papers “An Optimal True-amplitude Least-squares Prestack Depth-migration Operator: Geophysics, 64(2), 508-515” (Chavent, G., and R.-E. Plessix, 1999) and “Evaluation of Poststack Migration in Terms of Virtual Source and Partial Derivative Wavefields: Journal of Seismic Exploration, 12, 17-37” (Shin, C., D.-J. Min, D. Yang and S.-K. Lee, 2003), reverse-time migration shares the same algorithm as waveform inversion. Waveform inversion is accomplished by back-propagating the residuals between measured field data and initial model responses, whereas reverse-time migration back-propagates measured field data.

Various sources were used in seismic exploration, but it was not easy to accurately detect the waveforms of the sources since there are non-linear wave propagation and noise near the sources, coupling between the sources and receives, etc. Existing reverse-time migration has been performed under an assumption that a source such as a Ricker wavelet is a true source. Accordingly, the existing reverse-time migration failed to reflect accurate sources, which became a factor limiting the resolution of reverse-time migration.

### SUMMARY

The following description relates to a technique for improving the resolution of reverse-time migration.

In one general aspect, there is provided a seismic imaging system including: Logarithmic back-propagation unit configured to back-propagate a ration of a logarithmic measured wavefield to modeling wavefield; a virtual source estimating unit configured to estimate virtual sources from a sources; and a first convolution unit configured to convolve the back-propagated measured data with the virtual sources and to output the results of the convolution.

The seismic imaging system further includes a filtering unit to separate the data that are far smaller or larger than the mean from the rest of the data.

The seismic imaging system further includes a normalized back-propagation unit configured to back-propagate a L1-norm of measured wavefield; and a second convolution unit configured to convolve the back-propagated measured data with the virtual sources and to output the results of the convolution.

Other features and aspects will be apparent from the following detailed description, the drawings, and the claims.

### BRIEF DESCRIPTION OF THE DRAWINGS

FIG. 1 is a diagram illustrating an example of a seismic imaging system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

As mentioned in the paper “Evaluation of Poststack Migration in Terms of Virtual Source and Partial Derivative Wavefields: Journal of Seismic Exploration, 12, 17-37” (Shin, C., D.-J. Min, D. Yang and S.-K. Lee, 2003), migration can generally be expressed as a zero-lag cross-correlation between the partial derivative wavefields with respect to an earth parameter (such as velocity, density or impedance) and the measured data on the receivers in the time domain, as follows.

$${φ}_{k} = {\sum }_{s = 1}^{nshot} {\int }_{0}^{{T}_{max}} {[ \frac{\partial {u}_{s} ( t )}{\partial {m}_{k}} ]}^{T} {d}_{s} ( t ) d t . \qquad ( 1 )$$

where φₖ denotes the 2D migration image for the k-th model parameter, Tₘₐₓ is the maximum record length,

$$\frac{\partial {u}_{s} ( t )}{\partial {m}_{k}}$$

is the partial derivative wavefield vector, dₛ(t) is the field data vector, and s indicates the shot number.

In the frequency domain, migration can be expressed using the Fourier transform pairs (Brigham, E. O., 1988, the Fast Fourier Transform and its Applications: Avantek, Inc., Prentice Hall.) as:

$${φ}_{k} = {\sum }_{s = 1}^{nshot} {\int }_{0}^{{ω}_{max}} Re \{ {[ \frac{\partial {\tilde{u}}_{s} ( ω )}{\partial {m}_{k}} ]}^{T} {\tilde{d}}_{s}^{*} ( ω ) \} d ω , \qquad ( 2 )$$

where ω is the angular frequency, ũₛ and \tilde{d}ₛ are the frequency-domain modeled and field data vectors, the superscript * denotes the complex conjugate, and Re indicates the real part of a complex value.

In waveform inversion, an objective function can be written as:

$$E = \frac{1}{2} {\sum }_{s = 1}^{nshot} {\int }_{0}^{{ω}_{max}} {{[ {\tilde{u}}_{s} ( ω ) - {\tilde{d}}_{s} ( ω ) ]}^{T} [ {\tilde{u}}_{s} ( ω ) - {\tilde{d}}_{s} ( ω ) ]}^{*} d ω , \qquad ( 3 )$$

where the superscript T represents the transpose of the vector and (ũₛ−\tilde{d}ₛ) is the residual vector between modeled and field data. The gradient is obtained by taking the partial derivative of the objective function with respect to the model parameter, which yields:

$$\frac{\partial E}{\partial {m}_{k}} = {\sum }_{s = 1}^{nshot} {\int }_{0}^{{ω}_{max}} Re \{ {( \frac{\partial {\tilde{u}}_{s}}{\partial {m}_{k}} )}^{T} {( {\tilde{u}}_{s} - {\tilde{d}}_{s} )}^{*} \} d ω , \qquad ( 4 )$$

It is seen that equation 2 has the same form as equation 4, which means that the reverse-time migration corresponds to the gradient in waveform inversion.

To obtain the migration image or gradient, the partial derivative wavefields in equation 2 have to be computed, which can be obtained by using a forward-modeling algorithm (Shin, C., S. Pyun, and J. B. Bednar, 2007, Comparison of Waveform Inversion, Part 1: Conventional Waveform vs. Logarithmic Wavefield: Geophys. Prosp., 55, 449-464). Frequency-domain wave modeling can be expressed in matrix form (Marfurt, K. J., 1984, Accuracy of Finite-difference and Finite-element Modeling of the Scalar and Elastic Wave Equation: Geophysics, 49, 533-549) as:

Sũₛ=f and (5)

S=K+iωC+ω²M, (6)

where f is the source vector, S is the complex impedance matrix originating from the finite-element or finite-difference methods, and K, C, and M are the stiffness, damping, and mass matrices, respectively. When the derivative of equation 5 with respect to the model parameter mₖ is taken, the partial derivative wavefields (Pratt, R. G., C. Shin, and G. J. Hicks, 1998, Gauss-Newton and Full Newton Methods in Frequency Domain Seismic Waveform Inversions: Geophys. J. Int., 133, 341-362) can be obtained as follows:

$$\begin{matrix}S \frac{\partial {\tilde{u}}_{s}}{\partial {m}_{k}} + \frac{\partial S}{\partial {m}_{k}} {\tilde{u}}_{s} = 0 \\ and & ( 7 ) \\ \frac{\partial {\tilde{u}}_{s}}{\partial {m}_{k}} = {S}^{- 1} {f}_{v} , & ( 8 )\end{matrix}$$

where fᵥ is the virtual source vector expressed by

$${f}_{v} = - \frac{\partial S}{\partial {m}_{k}} {\tilde{u}}_{s} .$$

Substituting equation 8 into equation 2 gives

$${φ}_{k} = {\sum }_{s = 1}^{nshot} {\int }_{0}^{{ω}_{max}} Re [ {{f}_{v}^{T} ( {S}^{T} )}^{- 1} {d}_{s}^{*} ] d ω \qquad ( 9 )$$

for the k-th model parameter. If all of the model parameters are considered, the virtual source vector is replaced with the virtual source matrix Fᵥ^{T}:

$$φ = {\sum }_{s = 1}^{nshot} {\int }_{0}^{{ω}_{max}} Re [ {{F}_{v}^{T} ( {S}^{T} )}^{- 1} {d}_{s}^{*} ] d ω . \qquad ( 10 )$$

In equation 10, the combination (S^{T})⁻¹dₛ* of the second and third terms mean the back-propagation of field data, because the complex impedance matrix S is symmetrical. By convolving the back-propagated field data with virtual sources, a reverse-time migration image is may be obtained.

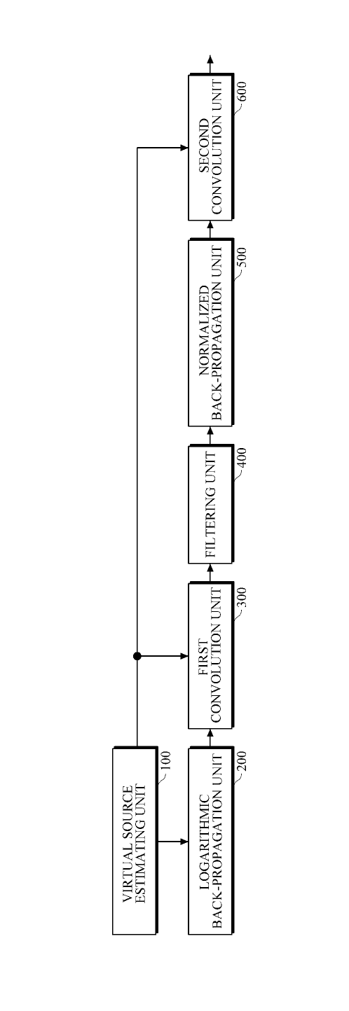

FIG. 1 is a diagram illustrating an example of a seismic imaging system. As illustrated in FIG. 1, the seismic imaging system comprises logarithmic back-propagation unit 200, virtual source estimating unit 100 and a first convolution unit 300. The logarithmic back-propagation unit 200 back-propagates a ration of a logarithmic measured wavefield to modeling wavefield. The virtual source estimating unit 100 estimates virtual sources from a sources. The first convolution unit 300 convolves the back-propagated measured data with the virtual sources and to output the results of the convolution.

The seismic imaging system may further include a filtering unit 400 to separate the data that are far smaller or larger than the mean from the rest of the data. And also, it may further include a normalized back-propagation unit 500 and a second convolution unit 600. The normalized back-propagation unit 500 back-propagates a L1-norm of measured wavefield, and the second convolution unit 600 convolves the back-propagated measured data with the virtual sources and to output the results of the convolution.

The following description is provided to explain the above elements in more details with is several equations below.

In the present invention, we mainly use the cross-correlation of the logarithmic modeled wavefield and the complex conjugate of the logarithmic measured wavefield. The reverse time migration using the logarithmic wavefields and its partial derivative can be expressed as

$$\begin{matrix}{Φ}_{k} = {\sum }_{s = 1}^{{N}_{s}} {\int }_{0}^{{ω}_{max}} Re [ {\{ ln ( {\tilde{u}}_{s} ( ω ) ) \}}^{T} ln ( {\tilde{d}}_{s}^{*} ( r , ω ) ) ] d ω , & ( 11 ) \\ \begin{matrix}{I}_{k} = \frac{\partial {Φ}_{k}}{\partial {p}_{k}} \\ = {\sum }_{s = 1}^{{N}_{s}} {\int }_{0}^{{ω}_{max}} Re [ {\{ \frac{1}{{\tilde{u}}_{s} ( ω )} \frac{\partial {\tilde{u}}_{s} ( ω )}{\partial {p}_{k}} \}}^{T} ln ( {\tilde{d}}_{s}^{*} ( r , ω ) ) ] d ω .\end{matrix} & ( 12 )\end{matrix}$$

Moreover, we apply a filter to separate the data that are far smaller or larger than the mean from the rest of the data. For the filtered data, we use the L₁-norm because it can effectively reduce the level of noise such as outliers and null data. We also describe the migration using the L₁-norm and its partial derivative as follows:

$$\begin{matrix}{Φ}_{k} = {\sum }_{s = 1}^{{N}_{s}} {\int }_{0}^{{ω}_{max}} Re [ {\{ {\tilde{x}}_{s} ( ω ) \}}^{T} {\tilde{y}}_{s}^{*} ( ω ) d ω ] , \\ {\tilde{x}}_{s} = sgn ( Re [ {\tilde{u}}_{s} ( ω ) ] ) + i sgn ( Im [ {\tilde{u}}_{s} ( ω ) ] ) , \\ {\tilde{y}}_{s} = sgn ( Re [ {\tilde{d}}_{s} ( ω ) ] ) + i sgn ( Im [ {\tilde{d}}_{s} ( ω ) ] ) . & ( 13 ) \\ \begin{matrix}{I}_{k} = \frac{\partial {Φ}_{k}}{\partial {p}_{k}} \\ = {\int }_{0}^{{ω}_{max}} {\sum }_{s = 1}^{{N}_{s}} Re [ {\{ \frac{\partial {\tilde{x}}_{s} ( ω )}{\partial {p}_{k}} \}}^{T} {\tilde{y}}_{s}^{*} ( ω ) ] d ω .\end{matrix} & ( 14 )\end{matrix}$$

where sgn( ) is the signum function.

Both the conventional and the present invention require the computation of the partial derivative wavefield,

$$\frac{\partial {\tilde{u}}_{s} ( ω )}{\partial {p}_{k}} ,$$

which we obtain from the forward modeling algorithm. We start from the 2D acoustic wave equation in the frequency domain, which can be expressed in a matrix form using the finite element method:

Sũₛ=\tilde{f},

S=K+iωC+ω²M, (15)

where M is the mass matrix, C is the damping matrix, K is the stiffness matrix, and f is the source vector. The vector of the partial derivative wavefield can then be obtained from the derivative of Equation 9 with respect to the model parameter:

$$\begin{matrix}S \frac{\partial {\tilde{u}}_{s}}{\partial {p}_{m}} + \frac{\partial S}{\partial {p}_{m}} {\tilde{u}}_{s} = 0 , \\ \frac{\partial {\tilde{u}}_{s}}{\partial {p}_{k}} = {S}^{- 1} {f}_{vs} , & ( 16 ) \\ {f}_{vs} = - \frac{\partial S}{\partial {p}_{k}} {\tilde{u}}_{s} , & ( 17 )\end{matrix}$$

where fᵥₛ is called the virtual source vector for the s^{th} shot.

In the present invention, we suggest the application of the logarithm and the L₁-norm to the reverse time migration algorithm to compensate for a weakness in the conventional algorithm, i.e., sensitivity to noise such as incorrect or null data. By applying the logarithm to the wavefield, we expect to mitigate the effects of incorrect data because the logarithmic wavefields are smoother than the conventional wavefields. Moreover, the application of logarithmic wavefields provides natural scaling characteristics by dividing the observed data by the modeled data. By the present invention, we can also mitigate the effects of outliers and null data with the is application of the L₁-norm, in which the filtered data are judged only by the signs of their real and imaginary parts.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A seismic imaging system comprising:
a logarithmic back-propagation unit configured to back-propagate a ration of a logarithmic measured wavefield to modeling wavefield;
a virtual source estimating unit configured to estimate virtual sources from sources; and
a first convolution unit configured to convolve the back-propagated measured data with the virtual sources and to output the results of the convolution.

2. The seismic imaging system in claim 1, further comprising:
a filtering unit to separate data that are far smaller or larger than a mean from the rest of the data.

3. The seismic imaging system in claim 1, further comprising:
is a normalized back-propagation unit configured to back-propagate a L1-norm of measured wavefield; and
a second convolution unit configured to convolve the back-propagated measured data with the virtual sources and to output the results of the convolution.

4. The seismic imaging system in claim 2, further comprising:
a normalized back-propagation unit configured to back-propagate a L1-norm of measured wavefield; and
a second convolution unit configured to convolve the back-propagated measured data with the virtual sources and to output the results of the convolution.
